(19) United States
(12) Patent Application Publication
(10) Pub. No.: US 2024/0174554 A1
(43) Pub. Date: May 30, 2024

(54) GLASS-BASED SUBSTRATES INCLUDING RECYCLED CONTENT, AND METHODS FOR PRODUCING THE SAME

(71) Applicant: CORNING INCORPORATED, CORNING, NY (US)

(72) Inventors: CAROL ANN CLICK, CORNING, NY (US); MATHIEU GERARD JACQUES HUBERT, CORNING, NY (US)

(21) Appl. No.: 18/389,311

(22) Filed: Nov. 14, 2023

Related U.S. Application Data
(60) Provisional application No. 63/460,634, filed on Apr. 20, 2023.
(60) Provisional application No. 63/428,985, filed on Nov. 30, 2022.

(51) Int. Cl. C03C 10/00

(52) U.S. Cl. CPC C03C 10/0027; C03C 10/0063; C03C 2203/10

(57) ABSTRACT

Glass-based substrates including recycled content of highly crystalized cullet are disclosed. Also disclosed are methods for manufacturing a recycled glass-based material composition, the method comprising: melting a set of raw materials, the set of raw materials comprising glass-ceramic cullet. The glass-ceramic cullet comprising: a cullet composition comprising SiO₂, Al₂O₃, and Li₂O; greater than or equal to 70% by total weight cullet crystal phase. The melting is performed in a melting vessel held at a temperature, and for a time, sufficient to melt the glass-ceramic cullet to form a re-melted precursor material. The melted precursor material may be used to form a glass-based product which may be transparent or opaque.

### CROSS-REFERENCE TO RELATED APPLICATIONS

This application claims the benefit of priority under 35 U.S.C. § 119 of U.S. Provisional Application Ser. No. 63/460,634 filed on Apr. 20, 2023 and U.S. Provisional Application Ser. No. 63/428,985 filed on Nov. 30, 2022, the contents of each of which are relied upon and incorporated herein by reference in their entireties.

### FIELD

The present disclosure relates generally to glass-based substrates and methods for producing them and, more particularly, to glass-based substrates including recycled content and methods of producing them.

### TECHNICAL BACKGROUND

Use of cullet (recycled glass either from manufacturing or post-consumer) in batch to produce new glass is common in glass production, and offers advantages as it allows a reduction in both raw material and energy consumptions. However, glass manufacturers try, to the extent possible, to avoid the use of crystallized material in the recycled cullet in batch, as crystals are typically hard to re-melt and can end up as defects in the new glass article produced. For example, cullet treatment plants (plants processing the post-consumer glass products and selling “clean” cullet back to glass producers) sort out the incoming cullet to remove pieces of glass-ceramics contained therein. Alternatively, the cullet treatment plants grind the cullet into a fine powder, promoting a faster remelt of possible crystalline material in the cullet. High levels of crystals in the cullet or large cullet pieces, as in the case of contamination by glass-ceramic material, are avoided.

Thus, there is a need to provide for recycling of high-crystal-phase glass-ceramic materials, as well as opaque glass-ceramic materials.

### SUMMARY

Glass-ceramic (GC) materials have been used widely in various applications. Glass-ceramic cooktop plates and cooking utensils have found wide applications in modern kitchens. Recently, Corning has developed transparent glass-ceramics for cover glass applications. A white opaque glass-ceramic material may be used for phone backs.

In this patent application, we present a process for re-using highly crystallized glass-ceramic cullet (including, for example, white opaque GC) to produce a re-melted precursor material and, as desired, a recycled glass-ceramic material. In addition, the re-melted precursor material may be used to produce a similar material as the cullet (in terms of crystal phase, transparency, and/or color), or a different material as the cullet (in terms of crystal phase, transparency, and/or color).

The accompanying drawings are included to provide a further understanding of the principles described, and are incorporated in and constitute a part of this specification. The drawings illustrate one or more embodiment(s), and together with the description serve to explain, by way of example, principles and operation of those embodiments. It is to be understood that various features disclosed in this specification and in the drawings can be used in any and all combinations. By way of non-limiting example the various features may be combined with one another as exemplified by the following aspects.

Aspect 1. A recycled glass-based product comprising:
a first composition comprising SiO₂, Al₂O₃, and Li₂O;
wherein a set of raw materials for preparing the composition of the recycled glass-based product comprises glass-ceramic cullet, the glass-ceramic cullet comprising:
a second composition comprising SiO₂, Al₂O₃, and Li₂O; and
greater than or equal to 70% by total weight crystal phase.

Aspect 2. The recycled glass-based product of aspect 1, wherein the cullet crystal phase comprises at least one of Li₂Si₂O5, Petalite, or B-spodumene.

Aspect 3. The recycled glass-based product of aspect 1 or aspect 2, wherein the glass-ceramic cullet comprises greater than or equal to 70%, by weight of the set of raw materials.

Aspect 4. The recycled glass-based product of any one of aspects 1-3, wherein the recycled glass-based product comprises a re-melted precursor material, the re-melted precursor material comprising less than 20% by total weight crystal phase.

Aspect 5. The recycled glass-based product of any one of aspects 1-3, wherein the recycled glass-based product comprises a recycled glass-ceramic comprising greater than or equal to 70% by total weight crystal phase.

Aspect 6. The recycled glass-based product of aspect 5, wherein the recycled glass-ceramic crystal phase comprises at least one of Li₂Si₂O₅, Petalite, or B-spodumene.

Aspect 7. The recycled glass-based product of aspect 5 or aspect 6, wherein the recycled glass-ceramic is transparent.

Aspect 8. The recycled glass-based product of aspect 5 or aspect 6, wherein the recycled glass-ceramic is opaque.

Aspect 9. The recycled glass-based product of aspect 8, wherein the recycled glass-ceramic is white.

Aspect 10. The recycled glass-based product of any one of aspects 1-9, wherein the first composition comprises (on an oxide basis):
greater than 50% by weight SiO₂;
greater than 5% by weight Al₂O₃; and
greater than 8% by weight Li₂O.

Aspect 11. The recycled glass-based product of aspect 10, wherein the first composition further comprises (on an oxide basis):
greater than 1.5% by weight ZrO₂; and
greater than 1% by weight P₂O₅.

Aspect 12. The recycled glass-based product of aspect 10 or aspect 11, wherein the first composition further comprises less than 4% by weight Na₂O.

Aspect 13. The recycled glass-based product of any one of aspects 1-12, wherein the second composition comprises (on an oxide basis):
greater than 50% by weight SiO₂;
greater than 5% by weight Al₂O₃; and
greater than 8% by weight Li₂O.

Aspect 14. The recycled glass-based product of aspect 13, wherein the second composition further comprises (on an oxide basis):
greater than 1.5% by weight ZrO₂; and
greater than 1% by weight P₂O₅.

Aspect 15. The recycled glass-based product of aspect 13 or 14, wherein the first composition further comprises less than 4% by weight Na₂O.

Aspect 16. The recycled glass-based product of any one of aspects 1-15, wherein the glass-ceramic cullet comprises pieces having a minimum size of about 1 mm to 50 mm.

Aspect 17. A method for manufacturing a recycled glass-based material composition, the method comprising:
melting a set of raw materials, the set of raw materials comprising glass-ceramic cullet, the glass-ceramic cullet comprising:
a cullet composition comprising SiO₂, Al₂O₃, and Li₂O;
greater than or equal to 70% by total weight cullet crystal phase, wherein the melting is performed in a melting vessel held at a temperature, and for a time, sufficient to melt the glass-ceramic cullet to form a re-melted precursor material.

Aspect 18. The method of aspect 17, wherein the temperature is in a range of 1000° C. to 1700° C.

Aspect 19. The method of aspect 17 or aspect 18, wherein the glass-ceramic cullet comprises greater than or equal to 70% by weight of the set of raw materials.

Aspect 20. The method of any one of aspects 17-19, wherein the re-melted precursor material comprises less than 20% by total weight of a crystal phase.

Aspect 21. The method of any one of aspects 17-20, wherein the glass-ceramic cullet comprises 100% of crystal phase by wt., and the re-melted precursor material comprises less than 5% crystal phase by wt.

Aspect 22. The method of any one of aspects 17-21, wherein the glass-ceramic cullet composition comprises (on an oxide basis):
greater than 50% by weight SiO₂;
greater than 5% by weight Al₂O₃; and
greater than 8% by weight Li₂O.

Aspect 23. The method of aspect 22, wherein the glass-ceramic cullet composition further comprises (on an oxide basis):
greater than 1.5% by weight ZrO₂; and
greater than 1% by weight P₂O₅.

Aspect 24. The method of aspect 22 or 23, wherein the glass-ceramic cullet further comprises less than 4% by weight Na₂O.

Aspect 25. The method of any one of aspects 17-24, wherein the glass-ceramic cullet crystal phase comprises at least one of Li₂Si₂O₅, Petalite, or B-spodumene.

Aspect 26. The method of any one of aspects 17-25, wherein the re-melted precursor material comprises a composition (on an oxide basis) of:
greater than 50% by weight SiO₂;
greater than 5% by weight Al₂O₃; and
greater than 8% by weight Li₂O.

Aspect 27. The method of aspect 26, wherein the re-melted precursor material further comprises (on an oxide basis):
greater than 1.5% by weight ZrO₂; and
greater than 1% by weight P₂O₅.

Aspect 28. The method of aspect 26 or aspect 27, wherein the re-melted precursor material further comprises less than 4% by weight Na₂O.

Aspect 29. The method of any one of aspects 17-28, further comprising annealing the re-melted precursor material in a furnace held at a temperature in a range from 300° C. to 700° C.

Aspect 30. The method of any one of aspects 17-29, further comprising ceramming the re-melted precursor material to form a recycled glass-ceramic comprising greater than or equal to 70, 75, 80, 85, 90, 95, 98% by total weight crystal phase.

Aspect 31. The method of aspect 30, wherein the recycled glass-ceramic crystal phase comprises at least one of at least one of Li₂Si₂O₅, Petalite, or B-spodumene.

Aspect 32. The method of aspect 30, wherein the recycled glass-ceramic crystal phase comprises Li₂Si₂O₅ and Petalite.

Aspect 33. The method of aspect 30, wherein the recycled glass-ceramic crystal phase comprises Li₂Si₂O₅ and B-spodumene.

Aspect 34. The method of any one of aspects 30-32, wherein the recycled glass-ceramic is transparent.

Aspect 35. The method of any one of aspects 30, 31, or 32, wherein the recycled glass-ceramic is opaque.

Aspect 36. The method of aspect 35, wherein the recycled glass-ceramic is white.

Aspect 37. The method of any one of aspects 30-36, wherein the recycled glass-ceramic comprises one or more crystal phases that were present in the glass-ceramic cullet.

Aspect 38. The method of any one of aspects 30-36, wherein the recycled glass-ceramic crystal phase comprises at least one crystal phase that was not present in the glass-ceramic cullet.

Aspect 39. The method of any one of aspects 30-38, wherein the wt. % crystal phase in the recycled glass-ceramic is within plus or minus 20%, 15%, 10%, preferably 5%, preferably 2%, of the wt. % crystal phase in the glass-ceramic cullet.

Aspect 40. The method of can one of aspects 17-29, wherein the glass-ceramic cullet comprises pieces having a minimum size of about 1 mm to about 50 mm.

Aspect 41. A glass-ceramic article made by the method set forth in any one of aspects 17-40.

The embodiments, and the features of those embodiments, as discussed herein are exemplary and can be provided alone or in any combination with any one or more features of other embodiments provided herein without departing from the scope of the disclosure. Moreover, it is to be understood that both the foregoing general description and the following detailed description present embodiments of the disclosure, and are intended to provide an overview or framework for understanding the nature and character of the embodiments as they are described and claimed. The accompanying drawings are included to provide a further understanding of the embodiments, and are incorporated into and constitute a part of this specification. The drawings illustrate various embodiments of the disclosure, and together with the description, serve to explain the principles and operations thereof.

### BRIEF DESCRIPTION OF THE DRAWINGS

FIG. 1 shows glass-ceramic cullet of Material C to be recycled.

FIG. 2 shows a sample of Material C and a Sample 1 re-melted precursor patty of transparent glass made from Material C.

FIG. 3 shows an X-Ray Diffraction (XRD—showing Intensity in courts on the y-axis, and Two-Theta in degrees on the x-axis) with no crystalline peaks (100% glassy material) for of Sample 1.

FIG. 4 shows a Sample 1 re-melted precursor patty of transparent glass made from Material C, a Sample 2 cerammed transparent glass-ceramic patty made from the re-melted precursor glass of Sample 1, and a sample of Material C.

FIG. 5 shows a Sample 1 re-melted precursor patty of transparent glass made from Material C, a Sample 2 cerammed transparent glass-ceramic patty made from the re-melted precursor glass of Sample 1, a Sample 3 cerammed opaque white glass-ceramic patty made from the re-melted precursor glass of Sample 1, and a sample of Material C.

FIG. 6 shows a Sample A, a transparent glass having no crystal phases by wt. %, i.e., the material is 100 wt. % glass.

FIG. 7 shows a Sample B, a transparent glass-ceramic.

### DETAILED DESCRIPTION

In the following detailed description, for purposes of explanation and not limitation, example embodiments disclosing specific details are set forth to provide a thorough understanding of various principles and aspects. However, it will be apparent to one having ordinary skill in the art, having had the benefit of the present disclosure, that the claimed subject matter may be practiced in other embodiments that depart from the specific details disclosed herein. Moreover, descriptions of well-known devices, methods and materials may be omitted so as not to obscure the description of various principles set forth herein. Finally, wherever applicable, like reference numerals refer to like elements. Methods and apparatus will now be described more fully hereinafter with reference to the accompanying drawings in which exemplary embodiments of the disclosure are shown. Whenever possible, the same reference numerals are used throughout the drawings to refer to the same or like parts. However, this disclosure may be embodied in many different forms and should not be construed as limited to the embodiments set forth herein.

In standard glass-making process, re-use of glass-ceramic cullet in the batch is avoided. Therefore, end-of-life glass-ceramic products cannot be re-used in batch to make new glass, and must be discarded, typically landfilled.

Here, we demonstrate a recycled glass-based product by using a high percentage (by weight) of cullet, wherein the cullet may be highly crystalized, and may be opaque. The recycled glass-based product may comprise a composition including SiO₂, Al₂O₃, and Li₂O. Thus, we show the recycling of a material that is typically difficult to recycle, and yet is beneficial to recycle due to the valuable lithium content. For example, the recycled glass-based product may include a composition that comprises (on an oxide basis, in wt. %): greater than 50% (for example greater than 60%, or greater than 65%) by weight SiO₂; greater than 5% (for example, greater than 6%, or greater than 7%) by weight Al₂O₃; and greater than 8% (for example, greater than 10%, or greater than 10.5%) by weight Li₂O. Additionally, the recycled glass-based product may further comprise (on an oxide basis): greater than 1.5% (for example, greater than 2%, or greater than 3%, or greater than 4%, or greater than 5%, or greater than 5.5%) by weight ZrO₂; and greater than 1% (for example, greater than 1.5%, or greater than 2%, or greater than 2.5%) by weight P₂O₅. Further, the recycled glass-based product may further comprise (on an oxide basis) less than 4% (for example, less than 3%, or less than 2.5%) by weight Na₂O.

A high percentage of cullet may be, for example, by weight of a set of raw materials for producing a glass-based product, greater than or equal to 70%, or greater than or equal to 75%, or greater than or equal to 80%, or greater than or equal to 85%, or greater than or equal to 90%, or greater than or equal to 95%, or greater than or equal to 98%, or greater than or equal to 99%, or 100%.

Highly crystallized cullet may be, for example, cullet having a total weight of crystal phase of greater than or equal to 70%, or greater than or equal to 75%, or greater than or equal to 80%, or greater than or equal to 85%, or greater than or equal to 90%, or greater than or equal to 95%, or greater than or equal to 98%, or 100%. The crystal phases may include, for example, Li₂Si₂O₅, Petalite, Beta-spodumene, Li₃PO₄, Tetragonal ZrO₂, Baddeleyite, or High quartz.

The cullet may be opaque or transparent, and may have a color, for example, white. Specifically, the cullet may contain, white glass-ceramic product.

The cullet may include a compositional make-up similar to that desired for the glass-based product to be made. For example, the cullet may have a composition comprising SiO₂, Al₂O₃, and Li₂O. For example, the cullet may include a composition that comprises (on an oxide basis in wt. %): greater than 50% (for example greater than 60%, or greater than 65%) by weight SiO₂; greater than 5% (for example, greater than 6%, or greater than 7%) by weight Al₂O₃; and greater than 8% (for example, greater than 10%, or greater than 10.5%) by weight Li₂O. Additionally, the cullet may further comprise (on an oxide basis): greater than 1.5% (for example, greater than 2%, or greater than 3%, or greater than 4%, or greater than 5%, or greater than 5.5%) by weight ZrO₂; and greater than 1% (for example, greater than 1.5%, or greater than 2%, or greater than 2.5%) by weight P₂O₅. Further, the cullet may further comprise (on an oxide basis) less than 4% (for example, less than 3%, or less than 2.5%) by weight Na₂O.

The cullet may include some relatively large sized pieces. Typically, when attempting to recycle glass-based materials, the cullet is ground into fine powder and sieved to sort out particles having a specific dimension or larger. In the present disclosure, however, we demonstrate that the cullet may include at least some relatively large sized pieces, for example, pieces having a minimum size of from about 1 millimeter (mm) to about 50 mm. For example, the cullet may comprise pieces having a minimum size of from about 1 mm to about 50 mm, or from about 2 mm to about 50 mm, or from about 3 mm to about 50 mm, or from about 4 mm to about 45 mm, or from about 5 mm to about 40 mm, or from about 10 mm to about 35 mm, or from about 15 mm to about 30 mm, or from about 1 mm to about 25 mm, or from about 1 mm to about 20 mm, or from about 1 mm to about 15 mm, or from about 1 mm to about 10 mm, or any and all subranges made with any and all of the foregoing end points.

Methods according to the present disclosure include melting a set of raw materials comprising glass-ceramic cullet, as described above. The melting is performed in a melting vessel held at a temperature, and for a time, sufficient to melt the glass-ceramic cullet to form a re-melted precursor material. The temperature may be in a range of 1000° C. to 1700° C. If the temperature is too low, then the glass-ceramic may not melt, the crystals may not dissolve, and/or the crystals may cause additional crystallization of the surrounding material. If the temperature is too high, then the process is not sustainable and/or may not be economically viable. For example, the temperature of the melting vessel may be from 1000° C. to 1600° C., or from 1000° C. to 1500° C., or from 1000° C. to 1400° C., or any and all subranges between any of the foregoing end points.

The re-melted precursor material may comprise an amount by weight of the original crystal phases from the glass-ceramic cullet that is less than 20 wt. %, including 0 wt. %, i.e., the re-melted precursor material may be a fully amorphous glass. For example the re-melted precursor material may comprise less than 20 wt. % total crystal phases, or less than 15 wt. % total crystal phases, or less than 10 wt. % total crystal phases, or less than 5 wt. % total crystal phases, or less than 2 wt. % total crystal phases, or less than 1 wt. % total crystal phases, or 0 wt. % total crystal phases, or any and all subranges comprised of any and all of the foregoing end points.

The re-melted precursor material may comprise a composition that it the same as that of the cullet in terms of compositional elements. For example, the re-melted precursor material may include a composition that comprises (on an oxide basis in wt. %): greater than 50% (for example greater than 60%, or greater than 65%) by weight SiO₂; greater than 5% (for example, greater than 6%, or greater than 7%) by weight Al₂O₃; and greater than 8% (for example, greater than 10%, or greater than 10.5%) by weight Li₂O. Additionally, the re-melted precursor material may further comprise (on an oxide basis): greater than 1.5% (for example, greater than 2%, or greater than 3%, or greater than 4%, or greater than 5%, or greater than 5.5%) by weight ZrO₂; and greater than 1% (for example, greater than 1.5%, or greater than 2%, or greater than 2.5%) by weight P₂O₅. Further, the re-melted precursor material may further comprise (on an oxide basis) less than 4% (for example, less than 3%, or less than 2.5%) by weight Na₂O.

The recycled glass-based product, or cullet, or re-melted precursor material, described herein may be generically described as lithium-containing aluminosilicate glasses or glass ceramics and comprise SiO₂, Al₂O₃, and Li₂O. In addition to SiO₂, Al₂O₃, and Li₂O, the glasses and glass ceramics embodied herein may further contain alkali salts, such as Na₂O, K₂O, Rb₂O, or Cs₂O, as well as P₂O₅, and ZrO₂ and a number of other components as described below. In one or more embodiments, the major crystallite phases include petalite and lithium silicate, but β-spodumene ss, β-quartz ss, lithium phosphate, cristobalite, and rutile may also be present as minor phases depending on the compositions of the precursor glass. In some embodiments, the glass-ceramic composition has a residual glass content of about 5 to about 30 wt. %, about 5 to about 25 wt. %, about 5 to about 20 wt. %, about 5 to about 15 wt. % about 5 to about 10 wt. %, about 10 to about 30 wt. %, about 10 to about 25 wt. %, about 10 to about 20 wt. %, about 10 to about 15 wt. %, about 15 to about 30 wt. %, about 15 to about 25 wt. %, about 15 to about 20 wt. %, about 20 to about 30 wt. % about 20 to about 25 wt. %, or about 25 to about 30 wt. %. In some embodiments the residual glass content can be 5, 6, 7, 8, 9, 10, 11, 12, 13, 14, 15, 16, 17, 18, 19, 20, 21, 22, 23, 24, 25, 26, 27, 28, 29, or 30 wt. %.

SiO₂, an oxide involved in the formation of glass, can function to stabilize the networking structure of glasses and glass ceramics. In some embodiments, the glass or glass ceramic composition comprises from about 50 to about 80 wt. % SiO₂. In some embodiments, the glass or glass ceramic composition comprises from 60 to about 80 wt. % SiO₂. In some embodiments, the glass or glass ceramic composition can comprise from about 50 to about 80 wt. %, about 55 to about 77 wt. %, about 55 to about 75 wt. %, about 55 to about 73 wt. %, 60 to about 80 wt. %, about 60 to about 77 wt. %, about 60 to about 75 wt. %, about 60 to about 73 wt. %, 65 to about 80 wt. %, about 65 to about 77 wt. %, about 65 to about 75 wt. %, about 65 to about 73 wt. %, 69 to about 80 wt. %, about 69 to about 77 wt. %, about 69 to about 75 wt. %, about 69 to about 73 wt. %, about 70 to about 80 wt. %, about 70 to about 77 wt. %, about 70 to about 75 wt. %, about 70 to about 73 wt. %, about 73 to about 80 wt. %, about 73 to about 77 wt. %, about 73 to about 75 wt. %, about 75 to about 80 wt. %, about 75 to about 77 wt. %, or about 77 to about 80 wt. %, SiO₂. In some embodiments, the glass or glass ceramic composition comprises about 55, 56, 57, 58, 59, 60, 61, 62, 63, 64, 65, 66, 67, 68, 69, 70, 71, 72, 73, 74, 75, 76, 77, 78, 79, or 80, wt. % SiO₂.

With respect to viscosity and mechanical performance, the viscosity and mechanical performance are influenced by glass compositions. In the glasses and glass ceramics, SiO₂ serves as the primary glass-forming oxide for the precursor glass and can function to stabilize the networking structure of glass and glass ceramic. The concentration of SiO₂ should be sufficiently high in order to form petalite crystal phase when the precursor glass is heat treated to convert to a glass-ceramic. The amount of SiO₂ may be limited to control melting temperature (200 poise temperature), as the melting temperature of pure SiO₂ or high-SiO₂ glasses is undesirably high.

Al₂O₃ may also provide stabilization to the network and also provides improved mechanical properties and chemical durability. If the amount of Al₂O₃ is too high, however, the fraction of lithium silicate crystals may be decreased, possibly to the extent that an interlocking structure cannot be formed. The amount of Al₂O₃ can be tailored to control viscosity. Further, if the amount of Al₂O₃ is too high, the viscosity of the melt is also generally increased. In some embodiments, the glass or glass ceramic composition can comprise from about 2 to about 20 wt. % Al₂O₃. In some embodiments, the glass or glass ceramic composition can comprise from about 6 to about 9 wt. % Al₂O₃. In some embodiments, the glass or glass ceramic composition can comprise from about 5 to about 20%, about 5 to about 18 wt. %, about 5 to about 15 wt. %, about 5 to about 12 wt. %, about 5 to about 10 wt. %, about 6 to about 9 wt. %, about 6 to about 8 wt. %, about 2 to about 5 wt. %, about 5 to about 20%, about 5 to about 18 wt. %, about 5 to about 15 wt. %, about 5 to about 12 wt. %, about 5 to about 10 wt. %, about 5 to about 9 wt. %, about 5 to about 8 wt. %, about 6 to about 20%, about 6 to about 18 wt. %, about 6 to about 15 wt. %, about 6 to about 12 wt. %, about 6 to about 10 wt. %, about 6 to about 9 wt. %, about 8 to about 20%, about 8 to about 18 wt. %, about 8 to about 15 wt. %, about 8 to about 12 wt. %, about 8 to about 10 wt. %, about 10 to about 20%, about 10 to about 18 wt. %, about 10 to about 15 wt. %, about 10 to about 12 wt. %, about 12 to about 20%, about 12 to about 18 wt. %, or about 12 to about 15 wt. %, Al₂O₃. In some embodiments, the glass or glass ceramic composition can comprise about 2, 3, 4, 5, 6, 7, 8, 9, 10, 11, 12, 13, 14, 15, 16, 17, 18, 19, or 20 wt. % Al₂O₃.

In the glass and glass ceramics herein, Li₂O aids in forming both petalite and lithium silicate crystal phases. In fact, to obtain petalite and lithium silicate as the predominant crystal phases, it is desirable to have at least about 7 wt. % Li₂O in the composition. Additionally, it has been found that once Li₂O gets too high—greater than about 15 wt. %—the composition becomes very fluid. In some embodied compositions, the glass or glass ceramic can comprise from about 5 wt. % to about 20 wt. % Li₂O. In other embodiments, the glass or glass ceramic can comprise from about 8 wt. % to about 14 wt. % Li₂O. In some embodiments, the glass or glass ceramic composition can comprise from about 8 to about 20 wt. %, about 8 to about 18 wt. %, about 8 to about 16 wt. %, about 8 to about 14 wt. %, about 8 to about 12 wt. %, about 8 to about 10 wt. %, about 5 to about 8 wt. %, 10 to about 20 wt. %, about 10 to about 18 wt. %, about 10 to about 16 wt. %, about 10 to about 14 wt. %, about 10 to about 12 wt. %, about 10.5 to about 20 wt. %, about 10.5 to about 18 wt. %, about 10.5 to about 16 wt. %, about 10.5 to about 14 wt. %, about 10.5 to about 12 wt. %, 12 to about 20 wt. %, about 12 to about 18 wt. %, about 12 to about 16 wt. %, about 12 to about 14 wt. %, 14 to about 20 wt. %, about 14 to about 18 wt. %, about 14 to about 16 wt. %, about 16 to about 20 wt. %, about 16 to about 18 wt. %, or about 18 to about 20 wt. % Li₂O. In some embodiments, the glass or glass ceramic composition can comprise about 5, 6, 7, 8, 9, 10, 11, 12, 13, 14, 15, 16, 17, 18, 19, or 20 wt. % Li₂O.

As noted above, Li₂O is generally useful for forming the embodied glass ceramics, but the other alkali oxides tend to decrease glass ceramic formation and form an aluminosilicate residual glass in the glass-ceramic. It has been found that more than about 5 wt. % Na₂O or K₂O, or combinations thereof, leads to an undesirable amount of residual glass which can lead to deformation during crystallization and undesirable microstructures from a mechanical property perspective. The composition of the residual glass may be tailored to control viscosity during crystallization, minimizing deformation or undesirable thermal expansion, or control microstructure properties. Therefore, in general, the compositions described herein have low amounts of non-lithium alkali oxides. In some embodiments, the glass or glass-ceramic composition can comprise less than 4% by wt. of Na₂O, for example, or less than 3% by wt., or less than 2.5% by wt. of Na₂O. In some embodiments, the glass or glass ceramic composition can comprise from about 0 to about 5 wt. % R₂O, wherein R is one or more of the alkali cations Na and K. In some embodiments, the glass or glass ceramic composition can comprise from about 1 to about 3 wt. % R₂O, wherein R is one or more of the alkali cations Na and K. In some embodiments, the glass or glass ceramic composition can comprise from 0 to about 5 wt. %, 0 to 4 wt. %, 0 to 3 wt. %, 0 to about 2 wt. %, 0 to about 1 wt. %, >0 to about 5 wt. %, >0 to about 4 wt. %, >0 to about 3 wt. %, >0 to about 2 wt. %, >0 to about 1 wt. %, about 1 to about 5 wt. %, about 1 to about 4 wt. %, about 1 to about 3 wt. %, about 1 to about 2 wt. %, about 2 to about 5 wt. %, about 2 to about 4 wt. %, about 2 to about 3 wt. %, about 3 to about 5 wt. %, about 3 to about 4 wt. %, or about 4 to about 5 wt. % Na₂O or K₂O, or combinations thereof. In some embodiments, the glass or glass ceramic composition can comprise about 0, >0, 1, 2, 3, 4, or 5 wt. % R₂O.

The glass and glass ceramic compositions can include P₂O₅. P₂O₅ can function as a nucleating agent to produce bulk nucleation. If the concentration of P₂O₅ is too low, the precursor glass does crystallize, but only at higher temperatures (due to a lower viscosity) and from the surface inward, yielding a weak and often deformed body; however, if the concentration of P₂O₅ is too high, the devitrification, upon cooling during precursor glass forming, can be difficult to control. Embodiments can comprise from >0 to about 6 wt. % P₂O₅. Other embodiments can comprise about 1 to about 4 wt. % P₂O₅. Still other embodiments can comprise about 1.5 to about 4 wt. % P₂O₅. Embodied compositions can comprise from 1 to about 6 wt. %, 1.5 to about 5.5 wt. %, 2 to about 5 wt. %, 2.5 to about 4.5 wt. %, 2 to about 4 wt. %, 2 to about 3.5 wt. %, 2 to about 3 wt. %, 2 to about 2.5 wt. %, 2 to about 4.5 wt. %, 2 to about 5.5 wt. %, 2.5 to about 6 wt. %, >0 to about 6 wt. %, >0 to about 5.5 wt. %, >0 to about 5 wt. %, >0 to about 4.5 wt. %, >0 to about 4 wt. %, >0 to about 3.5 wt. %, >0 to about 3 wt. %, >0 to about 2.5 wt. %, >0 to about 2 wt. %, >0 to about 1.5 wt. %, >0 to about 1 wt. %, about 0.5 to about 6 wt. %, about 0.5 to about 5.5 wt. %, about 0.5 to about 5 wt. %, about 0.5 to about 4.5 wt. %, about 0.5 to about 4 wt. %, about 0.5 to about 3.5 wt., about 0.5 to about 3 wt. %, about 0.5 to about 2.5 wt. %, about 0.5 to about 2 wt. %, about 0.5 to about 1.5 wt. %, about 0.5 to about 1 wt. %, about 1 to about 6 wt. %, about 1 to about 5.5 wt. %, about 1 to about 5 wt. %, about 1 to about 4.5 wt. %, about 1 to about 4 wt. %, about 1 to about 3.5 wt. %, about 1 to about 3 wt. %, about 1 to about 2.5 wt. %, about 1 to about 2 wt. %, about 1 to about 1.5 wt. %, about 1.5 to about 6 wt. %, about 1.5 to about 5.5 wt. %, about 1.5 to about 5 wt. %, about 1.5 to about 4.5 wt. %, about 1.5 to about 4 wt. %, about 1.5 to about 3.5 wt. %, about 1.5 to about 3 wt. %, about 1.5 to about 2.5 wt. %, about 1.5 to about 2 wt. %, about 2 to about 6 wt. %, about 2 to about 5.5 wt. %, about 2 to about 5 wt. %, about 2 to about 4.5 wt. %, about 2 to about 4 wt. %, about 2 to about 3.5 wt. %, about 2 to about 3 wt. %, about 2 to about 2.5 wt. %, about 2.5 to about 6 wt. %, about 2.5 to about 5.5 wt. %, about 2.5 to about 5 wt. %, about 2.5 to about 4.5 wt. %, about 2.5 to about 4 wt. %, about 2.5 to about 3.5 wt. %, about 2.5 to about 3 wt. %, about 3 to about 6 wt. %, about 3 to about 5.5 wt. %, about 3 to about 5 wt. %, about 3 to about 4.5 wt. %, about 3 to about 4 wt. %, about 3 to about 3.5 wt. %, about 3.5 to about 6 wt. %, about 3.5 to about 5.5 wt. %, about 3.5 to about 5 wt. %, about 3.5 to about 4.5 wt. %, about 3.5 to about 4 wt. %, about 4 to about 6 wt. %, about 4 to about 5.5 wt. %, about 4 to about 5 wt. %, about 4 to about 4.5 wt. %, about 4.5 to about 6 wt. %, about 4.5 to about 5.5 wt. %, about 4.5 to about 5 wt. %, about 5 to about 6 wt. %, about 5 to about 5.5 wt. %, or about 5.5 to about 6 wt. % P₂O₅. In some embodiments, the glass or glass ceramic composition can comprise about 0, >0, 0.5, 1, 1.5, 2, 2.5, 3, 3.5, 4, 4.5, 5, 5.5, or 6 wt. % P₂O₅.

In the glass and glass ceramics herein, it is generally found that ZrO₂ can improve the stability of Li₂O—Al₂O₃—SiO₂—P₂O₅ glass by significantly reducing glass devitrification during forming and lowering liquidus temperature. At concentrations above 8 wt. %, ZrSiO₄ can form a primary liquidus phase at a high temperature, which significantly lowers liquidus viscosity. Transparent glasses can be formed when the glass contains over 2 wt. % ZrO₂. The addition of ZrO₂ can also help decrease the petalite grain size, which aids in the formation of a transparent glass-ceramic. In some embodiments, the glass or glass ceramic composition can comprise from about 0.2 to about 15 wt. % ZrO₂. In some embodiments, the glass or glass ceramic composition can be from about 2 to about 4 wt. % ZrO₂. In some embodiments, the glass or glass ceramic composition can comprise from about 0.2 to about 15 wt. %, about 0.2 to about 12 wt. %, about 0.2 to about 10 wt. %, about 0.2 to about 8 wt. %, about 0.2 to 6 wt. %, about 0.2 to about 4 wt. %, 1.5 to about 15 wt. %, about 1.5 to about 12 wt. %, about 1.5 to about 10 wt. %, about 1.5 to about 8 wt. %, about 1.5 to 6 wt. %, 1 to about 15 wt. %, about 1 to about 12 wt. %, about 1 to about 10 wt. %, about 1 to about 8 wt. %, about 1 to 6 wt. %, 2 to about 15 wt. %, about 2 to about 12 wt. %, about 2 to about 10 wt. %, about 2 to about 8 wt. %, about 2 to 6 wt. %, about 3 to about 15 wt. %, about 3 to about 12 wt. %, about 3 to about 10 wt. %, about 3 to about 8 wt. %, about 3 to 6 wt. %, about 4 to about 15 wt. %, about 4 to about 12 wt. %, about 4 to about 10 wt. %, about 4 to about 8 wt. %, about 4 to 6 wt. %, about 5 to about 15 wt. %, about 5 to about 12 wt. %, about 5 to about 10 wt. %, about 5 to about 8 wt. %, about 5 to about 6 wt. %, about 5.5 to about 15 wt. %, about 5.5 to about 12 wt. %, about 5.5 to about 10 wt. %, about 5.5 to about 8 wt. %, about 5.5 to about 6.6 wt. %, or about 1.5 wt. % to 8 wt. % ZrO₂. In some embodiments, the glass or glass ceramic composition can comprise about 0.2, 0.5, 1, 2, 3, 4, 5, 6, 7, 8, 9, 10, 11, 12, 13, 14, or 15 wt. % ZrO₂.

B₂O₃ is conducive to providing a precursor glass with a low melting temperature. Furthermore, the addition of B₂O₃ in the precursor glass and thus the glass-ceramics helps achieve an interlocking crystal microstructure and can also improve the damage resistance of the glass ceramic. When boron in the residual glass is not charge balanced by alkali oxides or divalent cation oxides, it will be in trigonal-coordination state (or three-coordinated boron), which opens up the structure of the glass. The network around these three-coordinated boron is not as rigid as tetrahedrally coordinated (or four-coordinated) boron. Without being bound by theory, it is believed that precursor glasses and glass ceramics that include three-coordinated boron can tolerate some degree of deformation before crack formation. By tolerating some deformation, the Vickers indentation crack initiation values are increased. Fracture toughness of the precursor glasses and glass ceramics that include three-coordinated boron may also be increased. Without being bound by theory, it is believed that the presence of boron in the residual glass of the glass ceramic (and precursor glass) lowers the viscosity of the residual glass (or precursor glass), which facilitates the growth of lithium silicate crystals, especially large crystals having a high aspect ratio. A greater amount of three-coordinated boron (in relation to four-coordinated boron) is believed to result in glass ceramics that exhibit a greater Vickers indentation crack initiation load. In some embodiments, the amount of three-coordinated boron (as a percent of total B₂O₃) may be about 40% or greater, 50% or greater, 75% or greater, about 85% or greater or even about 95% or greater. The amount of boron in general should be controlled to maintain chemical durability and mechanical strength of the cerammed bulk glass ceramic.

In one or more embodiments, the glasses and glass ceramic herein can comprise from 0 to about 10 wt. % or from 0 to about 2 wt. % B₂O₃. In some embodiments, the glass or glass ceramic composition can comprise from 0 to about 10 wt. %, 0 to about 9 wt. %, 0 to about 8 wt. %, 0 to about 7 wt. %, 0 to about 6 wt. %, 0 to about 5 wt. %, 0 to about 4 wt. %, 0 0 to about 3 wt. %, 0 to about 2 wt. %, 0 to about 1 wt. %, >0 to about 10 wt. %, >0 to about 9 wt. %, >0 to about 8 wt. %, >0 to about 7 wt. %, >0 to about 6 wt. %, >0 to about 5 wt. %, >0 to about 4 wt. %, >0 to about 3 wt. %, >0 to about 2 wt. %, >0 to about 1 wt. %, about 1 to about 10 wt. %, about 1 to about 8 wt. %, about 1 to about 6 wt. %, about 1 to about 5 wt. %, about 1 to about 4 wt. %, about 1 to about 2 wt. %, about 2 to about 10 wt. %, about 2 to about 8 wt. %, about 2 to about 6 wt. %, about 2 to about 4 wt. %, about 3 to about 10 wt. %, about 3 to about 8 wt. %, about 3 to about 6 wt. %, about 3 to about 4 wt. %, about 4 to about 5 wt. %, about 5 wt. % to about 8 wt. %, about 5 wt. % to about 7.5 wt. %, about 5 wt. % to about 6 wt. %, or about 5 wt. % to about 5.5 wt. % B₂O₃. In some embodiments, the glass or glass ceramic composition can comprise about 0, >0, 1, 2, 3, 4, 5, 6, 7, 8, 9, or 10 wt. % B₂O₃.

MgO can enter petalite crystals in a partial solid solution. In one or more embodiments, the glasses and glass ceramic herein can comprise from 0 to about 8 wt. % MgO. In some embodiments, the glass or glass ceramic composition can comprise from 0 to about 8 wt. %, 0 to about 7 wt. %, 0 to about 6 wt. %, 0 to about 5 wt. %, 0 to about 4 wt. %, 0 to about 3 wt. %, 0 to about 2 wt. %, 0 to about 1 wt. %, about 1 to about 8 wt. %, about 1 to about 7 wt. %, about 1 to about 6 wt. %, about 1 to about 5 wt. %, about 1 to about 4 wt. %, about 1 to about 3 wt. %, about 1 to about 2 wt. %, about 2 to about 8 wt. %, about 2 to about 7 wt. %, about 2 to about 6 wt. %, about 2 to about 5 wt. %, about 2 to about 4 wt. %, about 2 to about 3 wt. %, about 3 to about 8 wt. %, about 3 to about 7 wt. %, about 3 to about 6 wt. %, about 3 to about 5 wt. %, about 3 to about 4 wt. %, about 4 to about 8 wt. %, about 4 to about 7 wt. %, about 4 to about 6 wt. %, about 4 to about 5 wt. %, about 5 to about 8 wt. %, about 5 to about 7 wt. %, about 5 to about 6 wt. %, about 6 to about 8 wt. %, about 6 to about 7 wt. %, or about 7 wt. % to about 8 wt. % MgO. In some embodiments, the glass or glass ceramic composition can comprise about 0, >0, 1, 2, 3, 4, 5, 6, 7, or 8 wt. % MgO.

ZnO can enter petalite crystals in a partial solid solution. In one or more embodiments, the glasses and glass ceramics herein can comprise from 0 to about 10 wt. % ZnO. In some embodiments, the glass or glass ceramic composition can comprise from 0 to about 10 wt. %, 0 to about 9 wt. %, 0 to about 8 wt. %, 0 to about 7 wt. %, 0 to about 6 wt. %, 0 to about 5 wt. %, 0 to about 4 wt. %, 0 to about 3 wt. %, 0 to about 2 wt. %, 0 to about 1 wt. %, about 1 to about 10 wt. %, about 1 to about 9 wt. %, about 1 to about 8 wt. %, about 1 to about 7 wt. %, about 1 to about 6 wt. %, about 1 to about 5 wt. %, about 1 to about 4 wt. %, about 1 to about 3 wt. %, about 1 to about 2 wt. %, about 2 to about 10 wt. %, about 2 to about 9 wt. %, about 2 to about 8 wt. %, about 2 to about 7 wt. %, about 2 to about 6 wt. %, about 2 to about 5 wt. %, about 2 to about 4 wt. %, about 2 to about 3 wt. %, about 3 to about 10 wt. %, about 3 to about 9 wt. %, about 3 to about 8 wt. %, about 3 to about 7 wt. %, about 3 to about 6 wt. %, about 3 to about 5 wt. %, about 3 to about 4 wt. %, about 4 to about 10 wt. %, about 4 to about 9 wt. %, about 4 to about 8 wt. %, about 4 to about 7 wt. %, about 4 to about 6 wt. %, about 4 to about 5 wt. %, about 5 to about 10 wt. %, about 5 to about 9 wt. %, about 5 to about 8 wt. %, about 5 to about 7 wt. %, about 5 to about 6 wt. %, about 6 to about 10 wt. %, about 6 to about 9 wt. %, about 6 to about 8 wt. %, about 6 to about 7 wt. %, about 7 to about 10 wt. %, about 7 to about 9 wt. %, about 7 wt. % to about 8 wt. %, about 8 to about 10 wt. %, about 8 to about 9 wt. %, or about 9 to about 10 wt. % ZnO. In some embodiments, the glass or glass ceramic composition can comprise about 0, >0, 1, 2, 3, 4, 5, 6, 7, 8, 9, or 10 wt. % ZnO.

In one or more embodiments, the glasses and glass ceramics herein can comprise from 0 to about 5 wt. % TiO₂. In some embodiments, the glass or glass ceramic composition can comprise from 0 to about 5 wt. %, 0 to about 4 wt. %, 0 to about 3 wt. %, 0 to about 2 wt. %, 0 to about 1 wt. %, about 1 to about 5 wt. %, about 1 to about 4 wt. %, about 1 to about 3 wt. %, about 1 to about 2 wt. %, about 2 to about 5 wt. %, about 2 to about 4 wt. %, about 2 to about 3 wt. %, about 3 to about 5 wt. %, about 3 to about 4 wt. %, or about 4 to about 5 wt. % TiO₂. In some embodiments, the glass or glass ceramic composition can comprise about 0, >0, 1, 2, 3, 4, or 5 wt. % TiO₂.

In one or more embodiments, the glasses and glass ceramics herein can comprise from 0 to about 0.4 wt. % CeO₂. In some embodiments, the glass or glass ceramic composition can comprise from 0 to about 0.4 wt. %, 0 to about 0.3 wt. %, 0 to about 0.2 wt. %, 0 to about 0.1 wt. %, about 0.1 to about 0.4 wt. %, about 1 to about 0.3 wt. %, about 1 to about 0.2 wt. %, about 0.2 to about 0.4 wt. %, about 0.2 to about 0.3 wt. %, or about 0.3 to about 0.4 wt. % CeO₂. In some embodiments, the glass or glass ceramic composition can comprise about 0, >0, 0.1, 0.2, 0.3, or 0.4 wt. % CeO₂.

In one or more embodiments, the glasses and glass ceramics herein can comprise from 0 to about 0.5 wt. % SnO₂. In some embodiments, the glass or glass ceramic composition can comprise from 0 to about 0.5 wt. %, 0 to about 0.4 wt. %, 0 to about 0.3 wt. %, 0 to about 0.2 wt. %, 0 to about 0.1 wt. %, about 0.05 to about 0.5 wt. %, 0.05 to about 0.4 wt. %, 0.05 to about 0.3 wt. %, 0.05 to about 0.2 wt. %, 0.05 to about 0.1 wt. %, about 0.1 to about 0.5 wt. %, about 0.1 to about 0.4 wt. %, about 0.1 to about 0.3 wt. %, about 0.1 to about 0.2 wt. %, about 0.2 to about 0.5 wt. %, about 0.2 to about 0.4 wt. %, about 0.2 to about 0.3 wt. %, about 0.3 to about 0.5 wt. %, about 0.3 to about 0.4 wt. %, or about 0.4 to about 0.5 wt. % SnO₂. In some embodiments, the glass or glass ceramic composition can comprise about 0, >0, 0.05, 0.1, 0.2, 0.3, 0.4, or 0.5 wt. % SnO₂.

In some embodiments, the sum of the weight percentage of P₂O₅ and ZrO₂ in the glasses and glass ceramics disclosed herein can be greater than or equal to about 3 wt. %, 4 wt. %, or 5 wt. % to increase nucleation. An increase in nucleation can lead to the production of finer grains.

The re-melted precursor material, as noted above, may be a fully amorphous glass, i.e., having no crystal phases present, and may be used as such. In this case, the re-melted precursor material becomes a recycled glass product. The recycled glass product is transparent. The recycled glass product may subsequently be strengthened. It is noteworthy that crystal phases including zirconia are able to be dissolved back into an amorphous glass at reasonable temperatures.

Optionally, an annealing step may be performed after forming the re-melted precursor material. The annealing step may be performed before using the re-melted precursor material as an amorphous glass product, or before the step of ceramming the re-melted precursor material to form a recycled glass-ceramic product. The step of annealing may be performed by holding the re-melted precursor material in a furnace, or other heating vessel, that is held at a temperature in a range from 300° C. to 700° C. For example, the annealing may be performed in a furnace at a temperature from 300° C. to 700° C., or from 300° C. to 600° C., or from 300° C. to 500° C., or from 400° C. to 700° C., or from 400° C. to 600° C., or from 500° C. to 600° C., or any and all sub-ranges formed by any and all of the endpoints of the foregoing ranges.

In other embodiments, the re-melted precursor material may be subject to a heat treatment cycle, i.e., a ceramming cycle, to produce new crystal phases and, thus, becomes a recycled glass-ceramic product. Depending on the ceramming cycle, the recycled glass-ceramic product may have similar crystal phases, in terms of amount in wt. % and kind, as the glass-ceramic cullet. For example, the glass-ceramic cullet may comprise crystal phases of at least one of Li₂Si₂O₅, Petalite, or B-spodumene, whereas the recycled glass-based product may comprise crystal phases of at least one of Li₂Si₂O₅, Petalite, or B-spodumene. For example, the glass-ceramic cullet may comprise crystal phases of Li₂Si₂O₅, and B-spodumene, and the recycled glass-ceramic product may comprise crystal phases of Li₂Si₂O₅ and B-spodumene. For example, the glass-ceramic cullet may comprise crystal phases of Li₂Si₂O₅, whereas the recycled glass-ceramic product may comprise crystal phases of Li₂Si₂O₅. Alternatively, the crystal phases, amount in wt. % and kind, may be different than those in the glass-ceramic cullet. For example, the glass-ceramic cullet may comprise crystal phases of Li₂Si₂O₅ and B-spodumene, whereas the recycled glass-ceramic product may comprise crystal phases of Li₂Si₂O₅, and Petalite. For example, the glass-ceramic cullet may comprise crystal phases of at least B-spodumene, whereas the recycled glass-ceramic product may comprise crystal phases that do not include B-spodumene. In terms of quantity of crystal phase, the recycled glass-ceramic product may have a wt. % crystal phase that is within plus or minus 30% of the wt. % crystal phase in the glass-ceramic cullet. For example, the recycled glass-ceramic product may have a wt. % crystal phase that is within plus or minus 30 wt. %, or 25 wt. %, or 20 wt. % or 15 wt. %, or 10 wt. %, or 5 wt. %, or 2 wt. % of the wt. % crystal phase in the glass-ceramic cullet. Alternatively, or in addition, the quantity of crystal phase in the recycled glass-ceramic product may be greater than or equal to 70 wt. %. For example, the recycled glass-ceramic product may have a crystal phase quantity of greater than or equal to 75 wt. %, or greater than or equal to 80 wt. %, or greater than or equal to 85 wt. %, or greater than or equal to 90 wt. %, or greater than or equal to 95 wt. %, or greater than or equal to 98 wt. %, or greater than or equal to 99 wt. %, or may be 100 wt. %, or any and all subranges of any and all endpoints in the foregoing. Moreover, the recycled glass-ceramic product may include crystal phases and be transparent. In some embodiments the recycled glass-ceramic product may include crystal phases and be opaque and/or or have color (including white). The recycled glass-ceramic product subsequently may be strengthened.

To demonstrate the above, experiments were carried out as set forth below, in which.

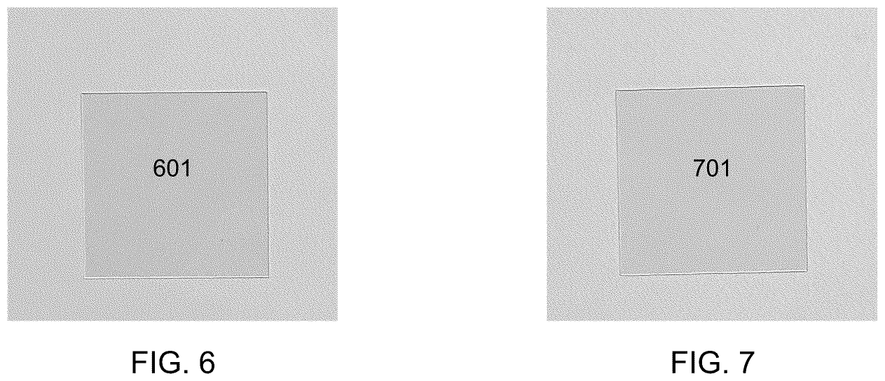

Sample A is a material having a composition of (on an oxide basis in terms of wt. %) 74.2 SiO₂, 7.5 Al₂O₃, 0.06 Na₂O, 0.12 K₂O, 11.3 Li₂O, 0.1 Fe₂O₃, 4.22 ZrO₂, 0.4 SnO₂, 2.1 P₂O₅, a phase assemblage as reported below in Table 1, i.e., is free of crystals, and is transparent. See, for example, 601 in FIG. 6.

Sample B is a material having a composition of (on an oxide basis in terms of wt. %) 74.2 SiO₂, 7.5 Al₂O₃, 0.06 Na₂O, 0.12 K₂O, 11.3 Li₂O, 0.1 Fe₂O₃, 4.22 ZrO₂, 0.4 SnO₂, 2.1 P₂O₅, a phase assemblage as reported below in Table 1, and is transparent. See, for example, 701 in FIG. 7. Sample B is made from the material of Sample A, and is subject to the Ceram Cycle as noted in Table 1, wherein the first time and temperature are for nucleation, and the second time and temperature are for crystallization.

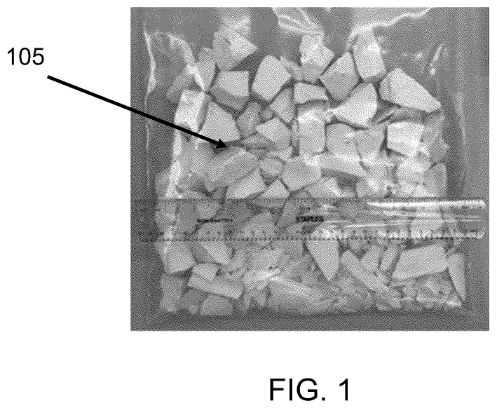

Sample C is a material having a composition of (on an oxide basis in terms of wt. %) 74.2 SiO₂, 7.5 Al₂O₃, 0.06 Na₂O, 0.12 K₂O, 11.3 Li₂O, 0.1 Fe₂O₃, 4.22 ZrO₂, 0.4 SnO₂, 2.1 P₂O₅, a phase assemblage as reported below in Table 1, and is opaque white. Sample C is made from the material of Sample A, and is subject to the Ceram Cycle as noted in Table 1, wherein the first time and temperature are for nucleation, and the second time and temperature are for crystallization. This is a highly crystallized material. Sample C is highly crystallized, and has a white opaque appearance. See, for example, 103 and 105 in FIGS. 1, 2, 4, and 5.

Sample A can be used to produce either a white, opaque glass-ceramic with a phase assemblage equivalent to Sample C, or a transparent glass-ceramic, with a phase assemblage equivalent to Sample B. The material of Sample A, as shown herein, can be obtained from melting cullet of Sample C. Hence, the present disclosure includes methods for recycling end-of-life white opaque glass-ceramic (e.g. Sample C), and the possibility of producing therefrom a new glass-ceramic article (Sample B or Sample C) based on the re-melted precursor material of Sample A.

The transparent glass-ceramic Sample B and the white opaque glass-ceramic Sample C can both be obtained from the precursor glass Sample A, by applying different thermal treatment (Ceram cycles). Table 1 shows the phase assemblages for the 3 materials. Sample A is fully amorphous (no crystals). Ceram cycles used to obtain these different materials (Samples B and C) is also presented in Table 1.

TABLE 1
phase assemblage (in wt. %) measured by XRD Rietveld Trace amounts
of other phases may be present, but are not reported.

| | Ceram | | | | Beta- | | Tetragonal | | High |
|---|---|---|---|---|---|---|---|---|---|
| Sample | Cycle | Glass | Li₂Si₂O₅ | Petalite | spod. | Li₃PO₄ | ZrO₂ | Baddeleyite | quartz |
| A | Not | 100 | 0 | 0 | 0 | 0 | 0 | 0 | 0 |
| | cerammed | | | | | | | | |
| B | 580 C./2 h 45 + | 13 | 44 | 43 | 0 | 0 | 0 | 0 | 0 |
| | 755 C./45 min | | | | | | | | |
| C | 800 C./4 h + | 0* | 43 | 0 | 50 | 4 | 2 | 1 | 0 |
| | 875 C./4 h | | | | | | | | |

*Phase assemblage below detection limit by Rietveld. However, while Rietveld reports indicate 0% glassy phase, it would be more accurate to consider it as “glassy phase < 5 wt. %.”

601—Sample A is a transparent glass having no crystal phases by wt. %, i.e., the material is 100 wt. % glass.
701—Sample B is a transparent glass-ceramic.
103—Sample C is an opaque white glass ceramic.
105—Cullet of Sample C.
201—Sample 1 is a re-melted precursor patty of transparent glass.
202—Sample 2 is a cerammed transparent glass-ceramic patty made from the re-melted precursor glass of Sample 1.
203—Sample 3 is a cerammed opaque white glass-ceramic patty made from the re-melted precursor glass of Sample 1.

### EXAMPLES

### Example 1

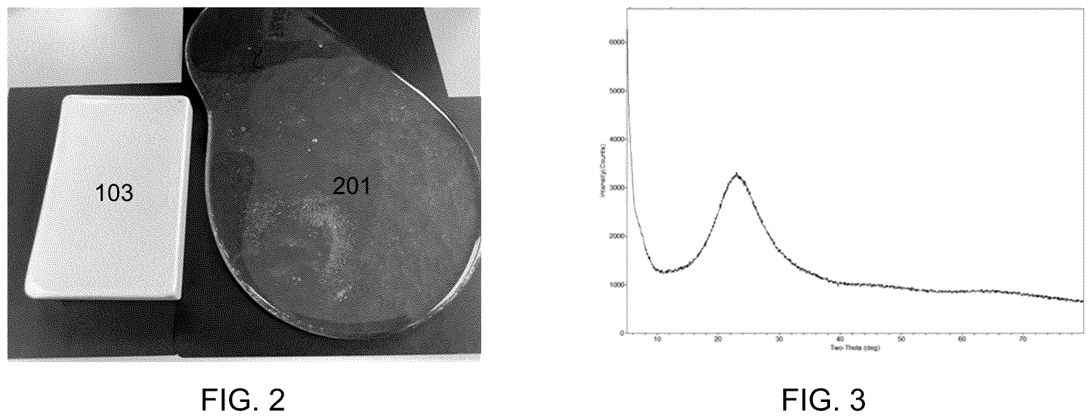

To evaluate the possibility of re-melting cullet (recycled glass-based material) of Sample C and use it in batch to produce glass, some Sample C material was crushed into coarse pieces of roughly 12.5 mm to 5 mm (0.5 to 2″ in) minimum size. See 105 in FIG. 1. About 2 Kg of this cullet was introduced in a platinum crucible and melted overnight at 1400° C., a typical melting temperature used in industrial glass melters. The cullet was kept in the furnace at this temperature overnight (about 16 hrs). The re-melted precursor glass obtained was then poured on a heated table, and then annealed at 500° C. resulting in Sample 1. See FIG. 2, reference 201, and Table 2 below.

As can be seen in FIG. 2, the material 201 of Sample 1 obtained after the remelt experiment is a clear, transparent material. A block of Sample C, reference 103, equivalent to the one used to produce the cullet 105 for this remelt experiment, is set next to the remelt patty 201, for comparison. This result shows that a temperature of 1400° C. is sufficient to remelt the crystal phases responsible for the white appearance of Sample C. An XRD analysis of this remelt patty 201 shows no crystalline peak (see FIG. 3), confirming the re-melted precursor glass obtained is fully amorphous and free of crystals. Therefore, a 100% amorphous glass can be obtained by remelting a batch of 100% cullet of highly crystallized Sample C after a few hours at a temperature typically used in industrial glass melters. This example shows producing a recycled amorphous glass product by using a high percentage (by weight) of cullet, wherein the cullet is highly crystalized, and opaque.

TABLE 2
Phase assemblage measured by XRD and Rietveld on the Sample
1, Sample 2 and Sample 3. The XRD and Rietveld data for
Sample B and for Sample C are provided for reference.

| | | | | Beta- | | Tetragonal | | High |
|---|---|---|---|---|---|---|---|---|
| Sample | Glass | Li₂Si₂O₅ | Petalite | spod. | Li₃PO₄ | ZrO₂ | Baddeleyite | quartz |
| B | 13 | 44 | 43 | 0 | 0 | 0 | 0 | 0 |
| C | 0* | 43 | 0 | 50 | 3.5 | 2.0 | 1.1 | 0 |
| 1 | 100 | 0 | 0 | 0 | 0 | 0 | 0 | 0 |
| 2 | 12 | 45 | 43 | 0 | 0 | 0 | 0 | 0 |
| 3 | 0* | 46 | 0 | 48 | 3 | 2 | 1 | trace |

*Phase assemblage below detection limit by Rietveld. However, while Rietveld reports indicate 0% glassy phase, “0% glassy phase” may be considered as a “glassy phase < 5 wt. %.”

### Example 2

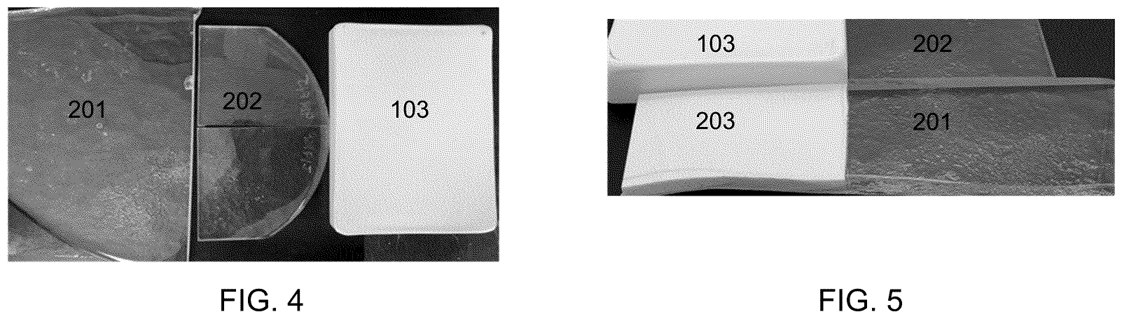

The glass obtained from Example 1 as Sample 1 was then heat-treated using the ceramming cycle for Sample B as indicated in Table 1, which resulted in Sample 2, shown in FIG. 4 by reference numeral 202. As can be seen in FIG. 4, Sample 2 remained transparent. An XRD and Rietveld analysis on Sample 2, Table 2, shows that the phase assemblage of Sample 2 is similar to the phase assemblage for the Sample B. This example shows producing a transparent recycled glass-ceramic product by using a high percentage (by weight) of cullet, wherein the cullet is highly crystalized, and opaque.

### Example 3

The glass obtained from Example 1 as Sample 1 was then heat-treated using the ceramming cycle for Sample C in Table 1, which resulted in Sample 3, shown in FIG. 5 by reference numeral 203. As can be seen in FIG. 5, a new white opaque glass-ceramic Sample 3, 203, can also be obtained from the re-melted precursor material of Sample 1. An XRD and Rietveld analysis on the Sample 3, Table 2, shows that the phase assemblage on this material is similar to the phase assemblage of Sample C. This example shows producing an opaque white recycled glass-ceramic product by using a high percentage (by weight) of cullet, wherein the cullet is highly crystalized, and opaque.

In conclusion, in this disclosure, there is shown the possibility of re-using a highly crystallized white opaque glass-ceramic to produce a material that is 100% amorphous and free of defects, using industry standard melting temperatures. In addition, the obtained glass can be heat-treated to produce either a new, transparent glass-ceramic product with a similar phase assemblage as compared to the material prepared from standard batch (i.e. without glass-ceramic cullet in batch); or cerammed back into a white opaque glass-ceramic with a phase assemblage similar to that of the original opaque glass-ceramic used as cullet for the remelt.

As used herein, the term “glass-based” includes both glasses and glass-ceramics, wherein glass-ceramics have one or more crystalline phases and an amorphous, residual glass phase. A glass-based material may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion-exchange of larger ions for smaller ions in the surface of the substrate, as discussed below. However, other strengthening methods known in the art, for example, thermal tempering, or utilizing a mismatch of the coefficient of thermal expansion between portions of the substrate to create compressive stress and central tension regions, may be utilized to form strengthened substrates.

As used herein, the term “white” means that the material, cullet, or glass-ceramic material, or glass-ceramic product, as the case may be, has a color presented in CIELAB color space coordinates: L*=85 to 100; a*=−2 to 8; and b*=−70 to 30. The CIELAB color space coordinates can be determined by methods known to those in the art using a Color i7 Spectrophotometer (X-Rite Incorporated, Grand Rapids, MI, USA) using an F02 illuminant under SCI UVC condition.

As used herein, the term “opaque” means that the material, or cullet, or glass-ceramic material, or glass-ceramic product, as the case may be, has an average opacity of 75 percent to 100 percent throughout the wavelength range of 400 nm to 700 nm for 0.8 mm in thickness 22. Average opacity can be determined using the contrast method with the Color 7 Spectrophotometer.

As used herein, the term “transparent” means that the material having a thickness of 1 mm achieves a transmittance of 85% of light (including surface reflection losses) over the wavelength range from about 400 nm to about 700 nm.

X-ray diffraction was utilized to determine the phase assemblage using Rietveld analysis. X-ray diffraction analysis techniques are known to those in the art, using such commercially available equipment as the model PW1830 (Cu Kα radiation) diffractometer manufactured by Philips, Netherlands.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, inward, outward—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

The term “or”, as used herein, is inclusive; more specifically, the phrase “A or B” means “A, B, or both A and B.” Exclusive “or” is designated herein by terms such as “either A or B” and “one of A or B,” for example.

As used herein, the terms “comprising” and “including,” and variations thereof, shall be construed as synonymous and open ended, unless otherwise indicated. A list of elements following the transitional phrases comprising or including is a non-exclusive list, such that elements in addition to those specifically recited in the list may also be present.

Moreover, where a range of numerical values is recited herein, comprising upper and lower values, unless otherwise stated in specific circumstances, the range is intended to include the endpoints thereof, and all integers and fractions within the range, and all ranges and sub-ranges between the foregoing values. It is not intended that the scope of the disclosure be limited to the specific values recited when defining a range. Further, when an amount, concentration, or other value or parameter is given as a range, one or more preferred ranges or a list of upper preferable values and lower preferable values, this is to be understood as specifically disclosing any and all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It is noted that one or more of the claims may utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

As a result of the raw materials and/or equipment used to produce the glass or glass ceramic composition of the present disclosure, certain impurities or components that are not intentionally added, can be present in the final glass or glass ceramic composition. Such materials are present in the glass or glass ceramic composition in minor amounts and are referred to herein as “tramp materials.”

As used herein, a glass or glass ceramic composition having 0 wt. % of a compound is defined as meaning that the compound, molecule, or element was not purposefully added to the composition, but the composition may still comprise the compound, typically in tramp or trace amounts. Similarly, “iron-free,” “sodium-free,” “lithium-free,” “zirconium-free,” “alkali earth metal-free,” “heavy metal-free” or the like are defined to mean that the compound, molecule, or element was not purposefully added to the composition, but the composition may still comprise iron, sodium, lithium, zirconium, alkali earth metals, or heavy metals, etc., but in approximately tramp or trace amounts.

It will be apparent to those skilled in the art that various modifications and variations can be made to the present disclosure without departing from the spirit and scope of the disclosure. Thus, it is intended that the present disclosure cover such modifications and variations provided they come within the scope of the appended claims and their equivalents.

What is claimed is:

1. A recycled glass-based product comprising:
a first composition comprising SiO₂, Al₂O₃, and Li₂O;
wherein a set of raw materials for preparing the composition of the recycled glass-based product comprises glass-ceramic cullet, the glass-ceramic cullet comprising:
a second composition comprising SiO₂, Al₂O₃, and Li₂O; and
greater than or equal to 70% by total weight crystal phase.

2. A method for manufacturing a recycled glass-based material composition, the method comprising:
melting a set of raw materials, the set of raw materials comprising glass-ceramic cullet, the glass-ceramic cullet comprising:
a cullet composition comprising SiO₂, Al₂O₃, and Li₂O; and
greater than or equal to 70% by total weight cullet crystal phase, wherein the melting is performed in a melting vessel held at a temperature, and for a time, sufficient to melt the glass-ceramic cullet to form a re-melted precursor material.

3. The method of claim 2, wherein the temperature is in a range of 1000° C. to 1700° C.

4. The method of claim 2, wherein the glass-ceramic cullet comprises greater than or equal to 70% by weight of the set of raw materials.

5. The method of claim 2, wherein the re-melted precursor material comprises less than 20% by total weight of a crystal phase.

6. The method of claim 2, wherein the glass-ceramic cullet comprises 100% of crystal phase by wt., and the re-melted precursor material comprises less than 5% crystal phase by wt.

7. The method of claim 2, wherein the glass-ceramic cullet composition comprises (on an oxide basis):
greater than 50% by weight SiO₂;
greater than 5% by weight Al₂O₃; and
greater than 8% by weight Li₂O.

8. The method of claim 7, wherein the glass-ceramic cullet composition further comprises (on an oxide basis):
greater than 1.5% by weight ZrO₂;
greater than 1% by weight P₂O₅; and
less than 4% by weight Na₂O.

9. The method of claim 2, wherein the glass-ceramic cullet crystal phase comprises at least one of Li₂Si₂O₅, Petalite, or B-spodumene.

10. The method of claim 2, wherein the re-melted precursor material comprises a composition (on an oxide basis) of:
greater than 50% by weight SiO₂;
greater than 5% by weight Al₂O₃;
greater than 8% by weight Li₂O;
greater than 1.5% by weight ZrO₂;
greater than 1% by weight P₂O₅; and
less than 4% by weight Na₂O.

11. The method of claim 2, further comprising annealing the re-melted precursor material in a furnace held at a temperature in a range from 300° C. to 700° C.

12. The method of claim 2, further comprising ceramming the re-melted precursor material to form a recycled glass-ceramic comprising greater than or equal to 70, 75, 80, 85, 90, 95, 98% by total weight crystal phase.

13. The method of claim 12, wherein the recycled glass-ceramic crystal phase comprises at least one of at least one of Li₂Si₂O₅, Petalite, or B-spodumene.

14. The method of claim 12, wherein the recycled glass-ceramic crystal phase comprises Li₂Si₂O₅ and Petalite.

15. The method of claim 12, wherein the recycled glass-ceramic is transparent.

16. The method of claim 12, wherein the recycled glass-ceramic comprises one or more crystal phases that were present in the glass-ceramic cullet.

17. The method of claim 12, wherein the recycled glass-ceramic crystal phase comprises at least one crystal phase that was not present in the glass-ceramic cullet.

18. The method of claim 12, wherein the wt. % crystal phase in the recycled glass-ceramic is within plus or minus 20% of the wt. % crystal phase in the glass-ceramic cullet.

19. The method of claim 2, wherein the glass-ceramic cullet comprises pieces having a minimum size of about 1 mm to about 50 mm.

20. A glass-ceramic article made by the method set forth in claim 2.
